(19) United States
(12) Patent Application Publication
(10) Pub. No.: US 2017/0214849 A1
(43) Pub. Date: Jul. 27, 2017

(54) METHOD AND SYSTEM OF AUTOMATICALLY RECORDING BABY PHOTO AND COMPUTER PROGRAM PRODUCT

(71) Applicant: VIVOTEK INC., New Taipei City (TW)

(72) Inventor: Jung-Jen LEE, New Taipei City (TW)

(21) Appl. No.: 15/407,951

(22) Filed: Jan. 17, 2017

(30) Foreign Application Priority Data
Jan. 26, 2016 (TW) 105102415

(51) Int. Cl. H04N 5/232; G06F 17/30; H04N 5/44; H04N 5/265; G06K 9/62; G06K 9/00

(52) U.S. Cl. CPC H04N 5/23222; G06K 9/6267; G06K 9/00335; H04N 5/44; H04N 5/23293; H04N 5/265; G06F 17/30256; G06F 17/3028

(57) ABSTRACT

A method and system of automatically recording baby photos and a computer program product can automatically capture baby photos according to a set shooting condition, and in a preset period, select a representative photo from the captured photos according to a set screening condition. Thus, users can save the process of repeatedly photographing and screening photos, and can directly enjoy the result of browsing photos of the growing process of the baby.

### CROSS-REFERENCE TO RELATED APPLICATION

This non-provisional application claims priority under 35 U.S.C. §119(a) to Patent Application No. 105102415 filed in Taiwan, R.O.C. on Jan. 26, 2016, the entire contents of which are hereby incorporated by reference.

### BACKGROUND

Technical Field

The present invention relates to a photo recording system, and particularly to a method of automatically recording baby photos and a baby photo recording system.

Related Art

With the prevalence of mobile computing devices, Apps have become software development projects for many software designers. There is a great variety of Apps, and the software designers also develop lots of Apps for applications such as photo management or diary. However, although the current Apps can provide an edit screen for users to add baby photos and edit texts, the users need to take photos in advance and manually add the photos after screening the photos on their own.

### SUMMARY

In view of the above problems, embodiments of the present invention propose a method and system of automatically recording baby photos and a computer program product, which can automatically capture baby photos according to a set shooting condition, and in a preset period, select a representative photo from the captured photos according to a set screening condition. Thus, users can save the process of repeatedly photographing and screening photos, and can directly enjoy the result of browsing photos of the growing process of the baby.

In an embodiment, the method of automatically recording baby photos includes: generating multiple image frames by shooting a baby; analyzing the image frames, to capture at least one of the image frames meeting a shooting condition as at least one target photo; storing the target photo; selecting, under a screening condition, one of the target photos in each preset period as a representative photo respectively; and placing the representative photos into a record template to form a photo record.

In another embodiment, the baby photo recording system includes: an image module, an analysis module, a screening module, at least one network transmission module, and at least one network receiving module. The image module may generate multiple image frames by shooting a baby. The analysis module analyzes the image frames, to capture at least one of the image frames meeting a shooting condition as at least one target photo. The screening module selects, under a screening condition, one of the target photos in each preset period as a representative photo respectively. The network transmission module transmits image data, the image data including at least one of the image frames, the at least one target photo, and the representative photos. The network receiving module receives the image data transmitted by the network transmission module.

In a further embodiment, the baby photo recording system includes: a network photographic device and a first remote processing device. The image module, the analysis module, and a first network transmission module are sequentially electrically connected to be disposed in the network photographic device, and a first network receiving module and the screening module are sequentially electrically connected to be disposed in the first remote processing device. The first network transmission module transmits the at least one target photo to the first network receiving module, to let the first remote processing device screen out a representative photo from the at least one target photo.

In another embodiment, the baby photo recording system includes: a network photographic device and a first remote processing device. The image module and a first network transmission module are sequentially electrically connected to be disposed in the network photographic device, and a first network receiving module, the analysis module, and the screening module are sequentially electrically connected to be disposed in the first remote processing device. The first network transmission module transmits the image frames to the first network receiving module, to let the first remote processing device capture at least one target photo from the image frames and screen out a representative photo therefrom.

In another embodiment, the baby photo recording system includes: a network photographic device and a first remote processing device. The image module, the analysis module, the screening module, and a first network transmission module are sequentially electrically connected to be disposed in the network photographic device, and a first network receiving module is disposed in the first remote processing device. The first network transmission module transmits the representative photos selected by the screening module to the first network receiving module.

In the foregoing embodiments, the first remote processing device may further include a recording module that places the representative photos into a record template to form a photo record.

In some embodiments, the baby photo recording system further includes a second remote processing device, to be online with the first remote processing device. A second network transmission module is disposed in the first remote processing device and electrically connected to the screening module, and a second network receiving module is disposed in the second remote processing device. The second network transmission module selects representative photos and transmits the representative photos to the second network receiving module. The second remote processing device further includes a recording module, electrically connected to the second network receiving module, to place the representative photos in a record template to form a photo record.

In a yet another embodiment, a computer program product is executed by a remote processing device, and cooperates with the baby photo recording system. The computer program product includes a communication module and a record generation module. The communication module receives, via a network interface, the representative photo in each default period transmitted from the network transmission module. The record generation module places the representative photos in a record template to form a photo record.

### BRIEF DESCRIPTION OF THE DRAWINGS

FIG. 1 is a schematic block diagram of a baby photo recording system according to a first embodiment of the present invention;

FIG. 2 is a schematic block diagram of a baby photo recording system according to a second embodiment of the present invention;

FIG. 3 is a schematic block diagram of a baby photo recording system according to a third embodiment of the present invention;

FIG. 4 is a schematic block diagram of a baby photo recording system according to a fourth embodiment of the present invention;

FIG. 5 is a schematic block diagram of a baby photo recording system according to a fifth embodiment of the present invention;

FIG. 6 is a schematic block diagram of a second remote processing device according to the first embodiment of the present invention;

FIG. 7 is a schematic diagram of a baby photos record according to the first embodiment of the present invention;

FIG. 8 is a schematic block diagram of a computer program product according to the first to fifth embodiments of the present invention;

FIG. 9 is another schematic diagram of a baby photos record according to the first to fifth embodiments of the present invention;

FIG. 10 is a flow chart of a method of automatically recording baby photos according to the first to fifth embodiments of the present invention; and

FIG. 11 is a schematic block diagram of a baby photo recording system according to a sixth embodiment of the present invention.

### DETAILED DESCRIPTION

It should be understood that, when “an embodiment” is described in the following, it indicates that the technical features, structures or characteristics described in combination with the embodiment may be included in at least one embodiment of the present invention. The expressions “in an embodiment” and “in some embodiments” appearing in the description may involve many different embodiments, and individual embodiments or other embodiments do not conflict with each other.

It should be understood that, when one element being “connected to” another element is described in the following, it may mean that two elements are directly connected or there is an intermediate element therebetween. On the contrary, when one element is “directly connected to” another element, there is no intermediate element.

The terms used herein are only for description of special embodiments, but are not used to limit the present invention. For example, identical element symbols in the full text represent identical elements. Although the terms such as “first” and “second” are used herein to describe different elements, the order of the elements is not limited by the terms. Herein, the term “and/or” used includes any or all combinations of one or more of the listed items. It should be understood that the singular forms “one” and “the” may also include plural forms, unless definitely indicated in the context.

It should also be understood that, when the term “include” or “have” is used in the description to describe existence of a certain feature, step, element and/or component, existence or addition of one or more other features, steps, elements, components and/or a combination thereof is not excluded.

In addition, “electrically connected” described hereinafter refers to making two devices or elements transfer an electrical signal therebetween by electrical coupling and/or electrical conduction.

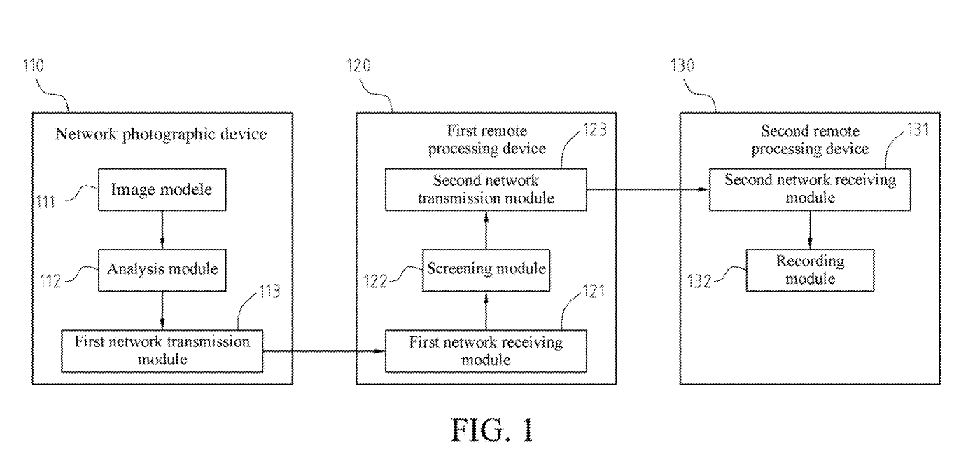

Referring to FIG. 1, it is a schematic block diagram of a baby photo recording system according to a first embodiment of the present invention. The baby photo recording system includes a network photographic device 110 and a first remote processing device 120, and can cooperate with a second remote processing device 130 of a user for use. The network photographic device 110 includes an image module 111, an analysis module 112, and a first network transmission module 113 electrically connected sequentially. The first remote processing device 120 includes a first network receiving module 121, a screening module 122, and a second network transmission module 123. The second remote processing device 130 includes a second network receiving module 131 and a recording module 132 electrically connected to each other. In some embodiments, the baby photo recording system includes the network photographic device 110, the first remote processing device 120, and the second remote processing device 130.

The network photographic device 110 may be a wired network camera, a wireless network camera or a digital camera or digital camcorder with a networking function, that is, the first network transmission module 113 may support wired network communication (e.g., Ethernet) and/or support wireless network communication (e.g., Wireless Fidelity, Wi-Fi) and can be connected to the Internet or a local area network. The first remote processing device 120 may be a computer device (e.g., server) having a great number of computing resources (e.g., processing power or storage capacity), and may be mounted to a rack or other stationary structures. However, the first remote processing device 120 may also be any computer unit providing information for other devices. Therefore, the first remote processing device 120 according to the embodiment of the present invention does not specifically limit the nature of the computing resources. Sometimes, a desktop computer, a laptop computer or a mobile device (e.g., mobile phones, tablets, etc.) may serve as the first remote processing device 120. The second remote processing device 130 may be an electronic device that can be connected to the Internet and/or a local area network, such as a desktop computer, a laptop computer or a mobile device (e.g., mobile phones, tablets, etc.).

In the network photographic device 110, the image module 111 includes components such as a lens and an image sensor, and can generate multiple image frames by shooting a baby. The image frames can be output in a video stream or be stored as one or more video files. The image module 111 can fixedly shoot towards a certain direction. In some embodiments, the image module 111 further includes a steering head, a drive motor, and a control chip, and can control a shooting direction automatically or under an external control.

The analysis module 112 may include a processor (not shown) having a computing capability, such as a microprocessor, a Complex Programmable Logic Device (CPLD) or a Field-Programmable Gate Array (FPGA). The analysis module 112 may include a storage unit (not shown), which may be a built-in non-transient memory built in the processor or an external non-transient memory located outside the processor and may store setting parameters including a shooting condition. In addition, the storage unit may also temporarily store image frames to be analyzed, for the processor to determine to capture which image frame or image frames meeting the shooting condition. In other words, after receiving the image frames output by the image module 111, the analysis module 112 may analyze the image frames. When the analyzed image frames meet the shooting condition, it may capture the image frames meeting the shooting condition as target photos. The captured target photos are stored in the storage unit. After analysis, the image frames temporarily stored in the storage unit may be deleted, and only desired target photos are kept, whereby the demand of storage capacity can be reduced. However, the embodiment of the present invention is not limited thereto, and in the case of having a sufficient storage capacity, the image frames may be kept continuously, to facilitate later use in need.

Herein, the shooting condition may be a detection parameter such as particular facial expressions (such as smile, cry, angry, yawn) and/or particular body movements (such as kick, wave, turn over) of the baby. The shooting condition may include one or more detection parameters. In the case of multiple detection parameters, the detection parameters may have an “AND” logic, “OR” logic, “NOT” logic or other logic relations therebetween.

In an embodiment, the shooting condition further includes a body variation amplitude. If the body variation amplitude is less than a default value than a previous image frame, the image is not captured, thereby reducing the data computing load.

In an embodiment, the analysis module 112 only analyzes one region in the image frames, to reduce the computing amount.

The first network transmission module 113 is connected to the Internet and/or the local area network, and can transmit one or more target photos to the first remote processing device 120. In addition, as required, the first network transmission module 113 may further transmit one or more of the image frames to the first remote processing device 120. In an embodiment, the network photographic device 110 may further include another network receiving module (not shown), and can receive, directly or via the first remote processing device 120, the shooting condition transmitted by the second remote processing device 130 via the Internet or the local area network, to set parameters. That is to say, the user can operate the second remote processing device 130 to set the shooting condition. However, the embodiment of the present invention is not limited thereto, and the shooting condition may also be preset.

In the first remote processing device 120, the first network receiving module 121 receives image data (i.e., target photos and/or image frames) transmitted by the first network transmission module 113. The screening module 122 includes a computing unit and a storage medium (not shown). The storage medium may be a hard disc, a solid-state drive, a memory card or a pen drive, etc. The computing unit may be a single-core or multi-core central processing unit. The storage medium may store the image data received by the first network receiving module 121, and may store the parameter setting including a screening condition. The computing unit selects, under the screening condition, one from the target photos in each preset period (e.g., one weak, one day, one hour or several hours, etc.) respectively as a representative photo. The selected representative photo is stored in the storage medium and can be transmitted by the second network transmission module 123 via the Internet and/or the local area network. The first network receiving module 121 and the second network transmission module 123 may support wired network communication (e.g., Ethernet) and/or support wireless network communication (e.g., Wi-Fi). Moreover, the first network receiving module 121 and the second network transmission module 123 may be integrated to the same network chip, and can receive and transmit data at the same time. Herein, the first network receiving module 121 may also receive the screening condition transmitted by the second remote processing device 130, to set parameters. That is to say, the user can operate the second remote processing device 130 to set the screening condition. However, the embodiment of the present invention is not limited thereto, and the screening condition may also be preset.

Herein, the screening condition may screen sequentially according to at least one part of the detection parameters. For example, target photos of smile are first screened, then target photos having a wave action are selected from the target photos of smile, next the target photos are screened under a condition of kicks, and finally target photos having smile, wave and kick actions at the same time can be selected. In other words, the screening condition may include multiple detection parameters, and the detection parameters have priority therebetween. The relation between the detection parameters, in addition to the “AND” logic, may also be other logic relations, such as “OR” logic and “NOT” logic.

In some embodiments, the screening condition may also, according to an image quality parameter of the target photos, for example, clarity and/or brightness, cause the screened target photos to be clear rather than out-of-focus photos or photos with inadequate or excessive brightness. That is to say, screening may be conducted with respect to the facial expressions and/or body movements, and then screening is conducted with respect to the image quality parameter. However, the embodiment of the present invention is not limited to the order, and vice versa.

In some embodiments, the analysis module 112 of the network photographic device 110 analyzes the image frames, to record a time stamp corresponding to image frames meeting the shooting condition in metadata. After the first network transmission module 113 of the network photographic device 110 transmits the image frames and the metadata to the first remote processing device 120, the screening module 122 of the first remote processing device can analyze the image frames corresponding to the time stamp according to the metadata, to capture the image frames meeting the shooting condition as target photos.

Through the above baby photo recording system, a representative photo in each preset period can be stored automatically. The second remote processing device 130 can obtain the representative photo in each preset period from the first remote processing device 120, enabling the user to easily recall changes in the growing process of the baby.

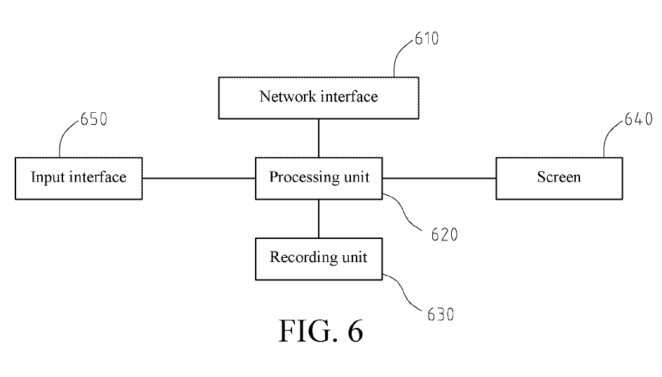

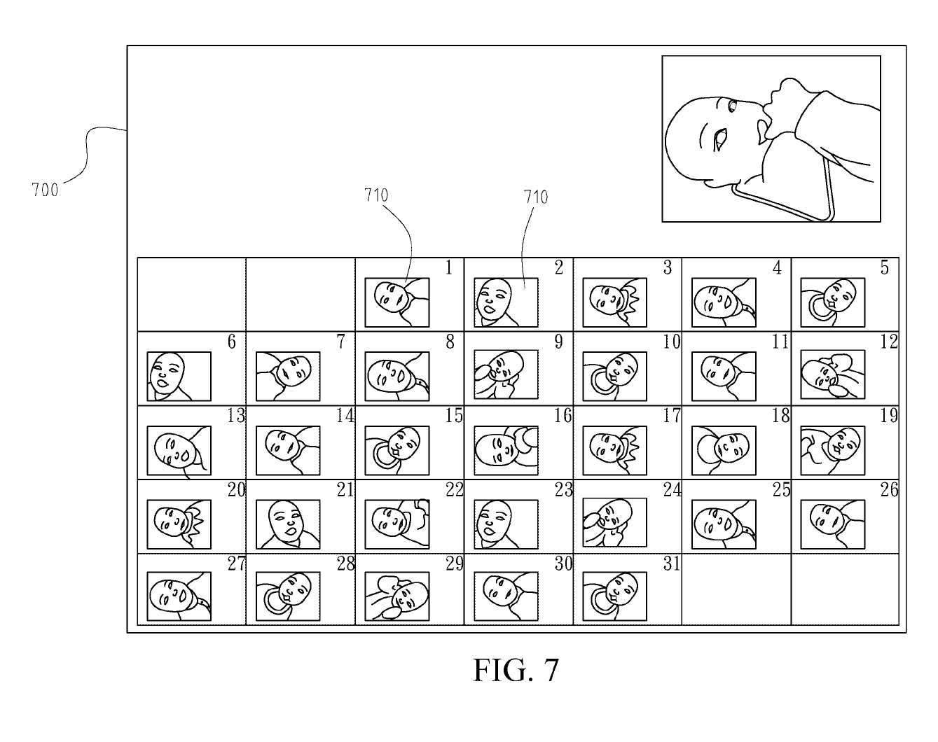

FIG. 6 is a schematic block diagram of a second remote processing device 130 according to a first embodiment of the present invention. The second remote processing device 130 includes a processing unit 620 and a network interface 610, a recording unit 630, a screen 640 and an input interface 650 electrically connected thereto. Referring to FIG. 1 and FIG. 6 together, the second network receiving module 131 of the second remote processing device 130 is the network interface 610 that can support wired network communication (e.g., Ethernet) and/or support wireless network communication (e.g., Wi-Fi, mobile communication technology), and can be connected to the Internet and/or the local area network, to receive the representative photo sent from the first remote processing device 120. The recording module 132 includes a processing unit 620 and a recording unit 630. The processing unit 620 may be a processor such as a System On Chip (SOC). The recording unit 630 may be a non-transient storage medium such as a flash memory, a memory card or a solid-state drive. The recording unit 630 may store an operating system, an App and the like run by the second remote processing device 130. The processing unit 620 may load an App, the App including one or more record templates (as shown in FIG. 7).

FIG. 7 is a schematic diagram of a baby photo record 700 according to the first embodiment of the present invention. The processing unit 620 may place the representative photos in a record template to form a photo record 700. Herein, a record template in the form of calendar is taken as an example, and there is a representative photo in each day. However, the embodiment of the present invention is not limited thereto, and the record template may also be in other forms such as diary or journal. Distributions and dimensions of representative photos of different record templates may vary according to arrangements.

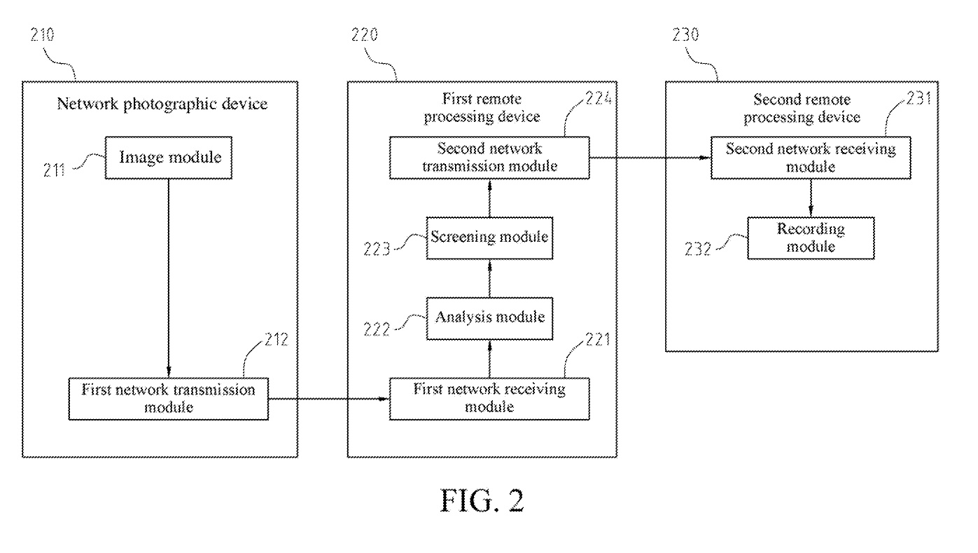

Referring to FIG. 2, it is a schematic block diagram of a baby photo recording system according to a second embodiment of the present invention. The same as the first embodiment, the baby photo recording system according to the second embodiment of the present invention also includes a network photographic device 210 and a first remote processing device 220, and can cooperate with a second remote processing device 230 of a user for use. In some embodiments, the baby photo recording system includes the network photographic device 210, the first remote processing device 220, and the second remote processing device 230. This embodiment is different from the first embodiment in that the network photographic device 210 in this embodiment does not have the analysis module 112, while an analysis module 222 is disposed in the first remote processing device 220. The analysis module 222 is electrically connected between a first network receiving module 221 and a screening module 223. That is to say, the network photographic device 210 in this embodiment includes an image module 211 and a first network transmission module 212 electrically connected to each other. The first remote processing device 220 includes a first network receiving module 221, an analysis module 222, a screening module 223 and a second network transmission module 224 electrically connected sequentially. The second remote processing device 230 includes a second network receiving module 231 and a recording module 232 electrically connected to each other. Only the difference is described below, and reference can be made to the first embodiment for the similarity, which is not repeated herein.

The first network transmission module 212 of the network photographic device 210 transmits the image frames generated by the image module 211 to the first remote processing device 220 via the Internet and/or a local area network. The first network receiving module 221 of the first remote processing device 220 receives the image frames transmitted by the network photographic device 210, and hands the image frames over to the analysis module 222 for analysis, and image frames meeting a shooting condition are captured as target photos. Then, the screening module 223 may select, under the shooting condition, one from the target photos in each default period as a representation photo. The second network transmission module 224 can, according to a request from the second remote processing device 230, transmit the representative photo to the second remote processing device 230 via the Internet and/or the local area network. In some embodiments, the analysis module 222 and the screening module 223 may be integrated together, and can capture target photos and select representative photos with a single processor (or computing unit), and store the target photos and the representative photos with a single storage unit (or storage medium). In addition, the storage unit and/or the storage medium may also store the received image frames, for the second remote processing device 230 to access.

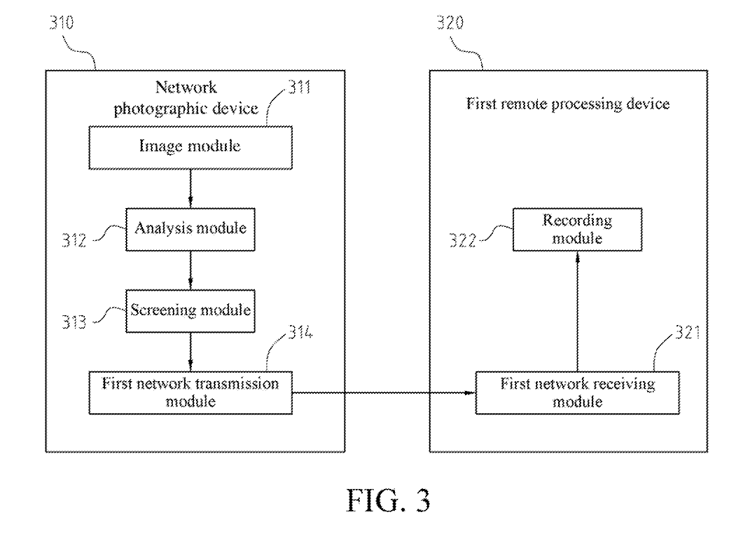

Referring to FIG. 3, it is a schematic block diagram of a baby photo recording system according to a third embodiment of the present invention. This embodiment is different from the first and second embodiments in that the baby photo recording system in this embodiment does not include a second remote processing device (130, 230), but directly provides a connection for a first remote processing device 320 of a user by a network photographic device 310. That is to say, the baby photo recording system includes a network photographic device 310 and a first remote processing device 320. Only the difference between this embodiment and the first and second embodiments is described below, and reference can be made to the first embodiment or the second embodiment for the similarity, which is not repeated herein.

As shown in FIG. 3, the network photographic device 310 includes an image module 311, an analysis module 312, a screening module 313, and a first network transmission module 314 electrically connected sequentially. As the analysis module 312 and the screening module 313 in this embodiment are both located in the network photographic device 310, the analysis module 312 analyzing image frames to capture image frames meeting a shooting condition as target photos and the screening module 313 selecting a representative photo from the target photos according to a screening condition are both accomplished in the network photographic device 310. In some embodiments, the analysis module 312 and the screening module 313 may be integrated together, and can capture target photos and select representative photos with a single processor (or computing unit), and store the target photos and the representative photos with a single storage unit (or storage medium). In addition, the storage unit and/or the storage medium may also store the received image frames, for the first remote processing device 320 to access.

The first remote processing device 320 of this embodiment includes a first network receiving module 321 and a recording module 322. The recording module 322 may place the representative photos in a record template to form a photo record 700. Different from the first and second embodiment, the first remote processing device 320 of this embodiment obtains one or more representative photos from the network photographic device 310, without screening the image frames or analyzing the target photos on its own.

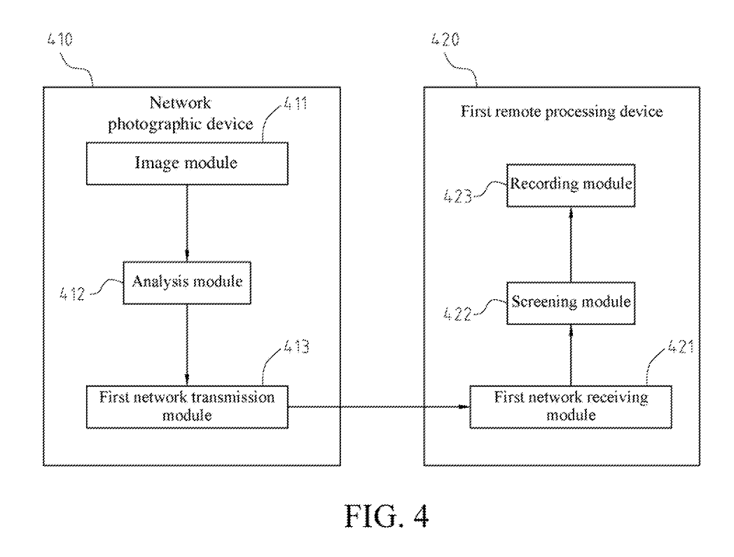

Referring to FIG. 4, it is a schematic block diagram of a baby photo recording system according to a fourth embodiment of the present invention. Similar to the third embodiment, the baby photo recording system of this embodiment includes a network photographic device 410 and a first remote processing device 420. The difference is that the network photographic device 410 of this embodiment does not have the screening module 313 of the third embodiment, but a screening module 422 is disposed in the first remote processing device 420. That is to say, the network photographic device 410 includes an image module 411, an analysis module 422, and a first network transmission module 413 electrically connected sequentially. The first remote processing device 420 includes a first network receiving module 421, a screening module 422, and a recording module 423 electrically connected sequentially. The analysis module 412 analyzes image frames generated by the image module 411, and captures image frames meeting a shooting condition as target photos. The first network transmission module 413 transmits one or more target photos to the first network receiving module 421 of the first remote processing device 420. The screening module 422 selects representative photos from the target photos according to a screening condition, for the recording modules 423 to place the representative photos in a record template to form the photo record 700.

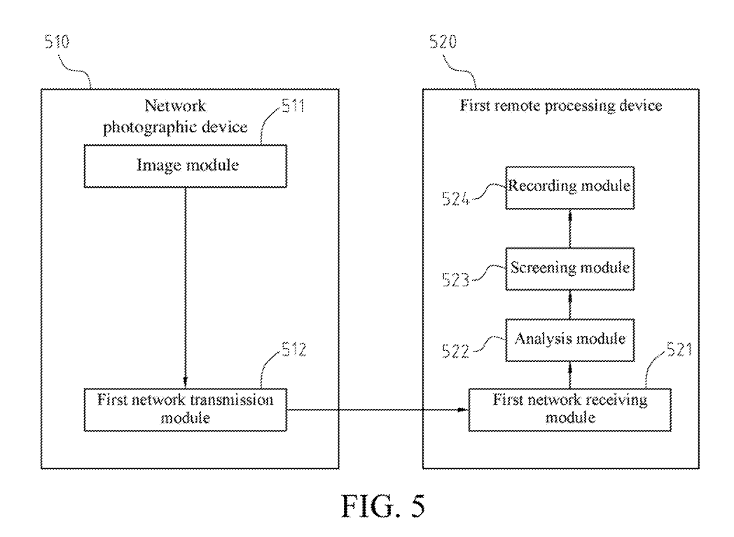

Referring to FIG. 5, it is a schematic block diagram of a baby photo recording system according to a fifth embodiment of the present invention. Similar to the third embodiment, the baby photo recording system of this embodiment includes a network photographic device 510 and a first remote processing device 520. The difference is that the network photographic device 510 of this embodiment does not have the analysis module 312 and the screening module 313 of the third embodiment, but an analysis module 522 and a screening module 523 are disposed in the first remote processing device 520. That is to say, the network photographic device 510 includes an image module 511 and a first network transmission module 512 electrically connected sequentially. The first remote processing device 520 includes a first network receiving module 521, an analysis module 522, a screening module 523, and a recording module 524 electrically connected sequentially. The first network transmission module 512 transmits image frames generated by the image module 511 to the first network receiving module 521. The analysis module 522 analyzes the image frames received by the first network receiving module 521, and captures image frames meeting a shooting condition as target photos. The screening module 523 selects representative photos from the target photos according to a screening condition, for the recording modules 524 to place the representative photos in a record template to form the photo record 700.

The hardware architecture of the first remote processing device (320, 420, 520) of the third to fifth embodiments may be the same as that shown in FIG. 6, which has a network interface 610, a processing unit 620, a recording unit 630, a screen 640, and an input interface 650. For example, the first remote processing device 320 may be a server, and display the photo record 700 on the screen 640; or the first remote processing device 320 may be a user end device, such as a desktop computer, a laptop computer or a mobile device.

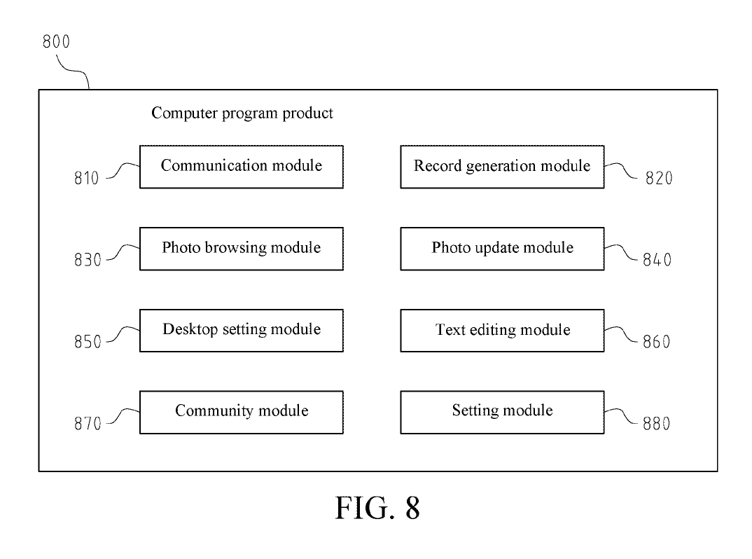

Referring to FIG. 8, it is a schematic block diagram of a computer program product 800 according to the first to fifth embodiments of the present invention. The computer program product 800 is an App, stored in the recording unit 630 of the second remote processing device (130, 230) in the first and second embodiments, or stored in the recording unit 630 of the first remote processing device (320, 420, 520) in the third to fifth embodiments, and can be executed by the processing unit 620. The computer program product 800 includes a communication module 810, a record generation module 820, a photo browsing module 830, a photo update module 840, a desktop setting module 850, a text editing module 860, a community module 870, and a setting module 880.

The communication module 810 may receive a representative photo in each default period via the network interface 610. The record generation module 820 stores one or more record templates, for the user to select a record template to be used, and places the representative photos in the selected record template to form a photo record 700 in the form of a file, which is stored in the recording unit 630. The record generation module 820 may read the photo record 700 stored in the recording unit 630, and display the photo record via the screen 640.

In the first and second embodiments, the communication module 810 may further receive other target photos which are not representative photos from the first remote processing device (120, 220) via the network interface 610. In the third embodiment, the communication module 810 may receive other target photos which are not representative photos from the network photographic device 310 via the network interface 610. In the fourth and fifth embodiments, the recording module (423, 524) of the first remote processing device (420, 520) has stored all the target photos. Therefore, in the first to fifth embodiments, the photo browsing module 830 may display multiple target photos (including representative photos and non-representative photos) corresponding to a particular period (e.g., one weak, one day, one hour or several hours, etc., which may generally match the foregoing preset period) via the screen 640. The photo browsing module 830 may detect an input of the user via an input interface 650 (e.g., a touch screen, a mouse, a keyboard, etc.), and in response to the input, selects one of the target photos corresponding to the particular period as an alternate photo. The record generation module 820 changes a representative photo in the photo records 700 corresponding to the particular period to the alternate photo. Thus, the user can replace the representative photos automatically selected originally by the baby photo recording system as other target photos at will according to preference.

The photo update module 840 may receive an updated photo imported externally (e.g., another App or file management system). The record generation module 820 may change a representative photo in the photo record 700 corresponding to a particular period into the updated photo. Thus, the user can replace the representative photo with another photo not captured by the baby photo recording system at will according to preference.

In some embodiments, as the screening module (122, 223) of the first remote processing device (120, 220) or the screening module 313 of the network photographic device 310 also stores representative photos of respective preset periods, the user may also change one or more representative photos stored by the first remote processing device (120, 220) or the network photographic device 310 into the alternate photo or updated photo.

Herein, how the one or more representative photos stored by the first remote processing device (120, 220) or the network photographic device 310 are changed is additionally explained. The communication module 810 may establish a link with the first remote processing device (120, 220) or the network photographic device 310, and the photo browsing module 830 may read and display the representative photos stored by the first remote processing device (120, 220) or the network photographic device 310, for the user to select. The communication module 810 may transmit the alternate photo selected by the user which is detected by the photo browsing module 830, or transmit the updated photo received by the photo update module 840. Hence, the first remote processing device (120, 220) or the network photographic device 310 can change the corresponding representative photo into the received alternate photo or updated photo.

In addition, at the beginning of executing the computer program product by the processing unit 620, the communication module 810 can connect the first remote processing device (120, 220) or the network photographic device 310 which stores representative photos via a network interface 610, to confirm whether the representative photos are changed. If yes, the communication module 810 may download a new representative photo, and the record generation module 820 may replace the representative photo corresponding to a preset period with the downloaded new representative photo. Thus, the user, if having multiple remote processing devices (i.e., first remote processing device (320) or second remote processing device (130, 230)), can keep consistency between the photo records 700 of the remote processing devices.

The desktop setting module 850 may periodically (e.g., every day) set the representative photo as an operating system scenery of the second remote processing device (130, 230) or the first remote processing device (320, 420, 520). For example, if the preset period is every day, the desktop setting module may set the latest representative photo of every day as an operating system scenery. The user can see different baby photos every day, thus providing freshness and interestingness.

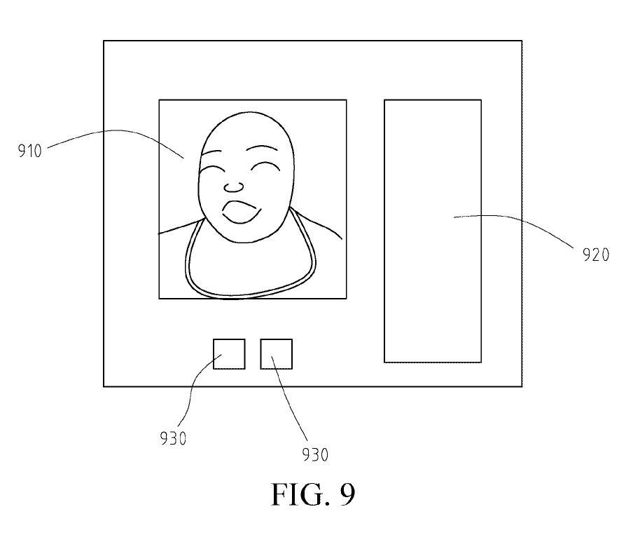

Referring to FIG. 9, it is another schematic diagram of a baby photo record according to the first to fifth embodiments of the present invention. If the user selects, via the input interface 650, a representative photo 710 in one day of the photo record 700 shown in FIG. 7, the user will enter the screen shown in FIG. 9. The selected representative photo 910 is displayed in the screen.

The text editing module 860 may provide a text edit region 920, and can receive a text input via the input interface 650 and add input texts to the record template, to form annotations corresponding to the representative photo 910. Thus, the user can add literal descriptions for each representative photo 910, so that memory will be left when the user recalls the photo record 700.

The community module 870 may provide a shared link 930 corresponding to the representative photo 910, and the community module 870, in response to a trigger from a certain shared link 930, may upload the corresponding representative photo 910 to a community platform via the communication module 810, so that photos can be shared with friends of the user via the community platform.

The setting module 880 may provide a set screen (not shown), and can, in response to an input of the user via the input interface 650, generate a parameter setting (e.g., the foregoing shooting condition and/or screening condition). The communication module 810 may transmit the parameter setting to the network photographic device (110, 210, 310, 410) or the first remote processing device (120, 220).

In combination with the first to fifth embodiments, the baby photo recording system includes a image module (111, 211, 311, 411, 511), an analysis module (122, 222, 312, 412, 522), a screening module (122, 223, 313, 422, 523), at least one network transmission module (which refers to the first network transmission module (113, 212) and the second network transmission module (123, 224) in the first and second embodiments; and refers to the first network transmission module (314, 413, 512) in the third to fifth embodiments), and at least one network receiving module (which refers to the first network receiving module (121, 221) and the second network receiving module (131, 231) in the first and second embodiments; and refers to the first network receiving module (321, 421, 521) in the third to fifth embodiments), and can automatically record photos of a baby, and select a representative photo 710 in a preset period. The at least one network transmission module and the at least one network receiving module are disposed in different positions but can cross geographical restrictions to allow the user to browse the photo record 700 presenting the representative photos 710. In some embodiments, the baby photo recording system further includes a recording module (132, 232, 322, 423, 524) located in the second remote processing device (130, 230) and the first remote processing device (320, 420, 520), electrically connected to a network receiving module (i.e., the second network receiving module (131, 231), the first network receiving module (321, 421, 521)).

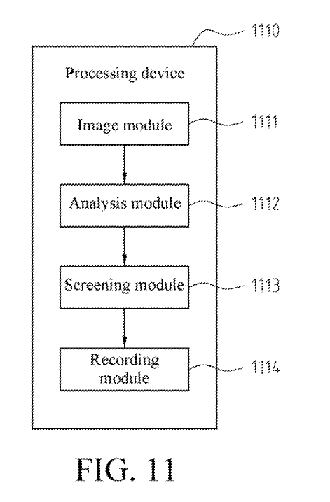

It should be particularly noted that, although the embodiment is described with two devices (e.g., the network photographic device 310 and the first remote processing device 320) or three devices (e.g., the network photographic device 110, the first remote processing device 120, and the second remote processing device 130), the present invention is not limited thereto. Herein, description is given based on a sixth embodiment. Referring to FIG. 11, this embodiment may also be implemented with a single processing device 1110. That is, an image module 1111, an analysis module 1112, a screening module 1113, and a recording module 1114 may be integrated into the processing device 1110. The processing device 1110 may be a desktop computer, a laptop computer or a mobile device (e.g., mobile phones, tablets, etc.). As this embodiment is implemented only with a processing device 1110, the network transmission module and the network receiving module in the foregoing embodiment are not required in the processing device 1110. Hence, the image module 1111 can directly provide image frames for the analysis module 1112; the analysis module 1112 can directly provide target photos for the screening module 1113; and the screening module 1113 can directly provide representative photos for the recording module 1114.

Further, compared with the hardware shown in FIG. 6, this embodiment may not have the network interface 610, but has a shooting unit (including components such as a lens and an image sensor) connecting the processing unit 620; compared with the computer program product shown in FIG. 8, this embodiment may not have the communication module 810 and the community module 870, but has an image module that can control the shooting unit to capture images. However, the embodiment of the present invention is not limited thereto. In an embodiment, the hardware of the processing device 1110 may still have the network interface 610; the computer program product executed by the processing device 1110 may still have the communication module 810. Through the communication module 810, the processing device 1110 may share or synchronously update the representative photos with other processing devices 1110 via the network interface 610, to enable multiple processing devices 1110 to have the same photo record 700. In addition, in an embodiment, the computer program product executed by the processing device 1110 may still have the community module 870, thereby sharing photos with friends of the user via a community platform.

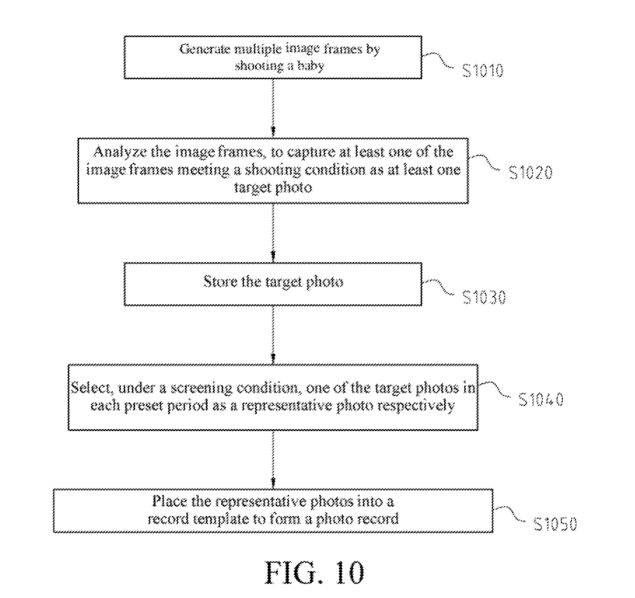

Referring to FIG. 10, it is a flow chart of a method of automatically recording baby photos according to the first to sixth embodiments of the present invention. Firstly, in step S1010, a baby is shot to generate multiple image frames. The image frames have the same time interval (e.g., 1/30 s) therebetween. Next, in step S1020, the image frames are analyzed, that is, image recognition are performed on the image frames, to capture at least one image frame meeting a shooting condition as at least one target photo. Then, the process proceeds to step S1030, in which the captured target photos are stored. Next, in step S1040, under a screening condition, one of the target photos in each default period is selected as a representative photo 710 respectively. Finally, the process goes to step S1050, the representative photos 710 are placed in a record template to form a photo record 700.

In an embodiment, step S1020 further includes the following steps: (1) analyzing the image frames; (2) storing a time stamp corresponding to the image frames meeting the shooting condition in metadata; and (3) searching and capturing the image frames corresponding to the time stamp according to the metadata. Target images can be quickly found according to the time stamp stored by the metadata, to facilitate screening in the subsequent step S1040.

To sum up, the method of automatically recording baby photos and the baby photo recording system proposed in the embodiments of the present invention can automatically record baby photos in each default period, and the user can set a screening condition on his/her own. In addition, the photo record 700 generated automatically enables the user to browse the photos conveniently.

What is claimed is:

1. A method of automatically recording baby photos, comprising:
generating multiple image frames by shooting a baby, wherein the multiple image frames are formed as a video stream or at least one video file;
analyzing the image frames, to capture at least one of the image frames meeting a shooting condition as at least one target photo;
storing the at least one target photo;
selecting, under a screening condition, one of the at least one target photo in each preset period as a representative photo respectively; and
placing the representative photos into a record template to form a photo record.

2. The method of automatically recording baby photos according to claim 1, wherein the shooting condition comprises at least one detection parameter, the at least one detection parameter is related to facial expressions or body movements of the baby.

3. The method of automatically recording baby photos according to claim 2, wherein the screening condition is screening sequentially according to at least one part of the at least one detection parameter.

4. The method of automatically recording baby photos according to claim 3, wherein the screening condition further comprises an image quality parameter of the target photo.

5. The method of automatically recording baby photos according to claim 1, wherein the step of analyzing the image frames, to capture at least one of the image frames meeting a shooting condition as at least one target photo comprises:
analyzing the image frames;
storing a time stamp corresponding to at least one of the image frames meeting the shooting condition in metadata; and
searching and capturing the at least one of the image frames corresponding to the time stamp according to the metadata.

6. A baby photo recording system, comprising:
an image module that generates multiple image frames by shooting a baby, wherein the multiple image frames are formed as a video stream or at least one video file;
an analysis module that analyzes the image frames, to capture at least one of the image frames meeting a shooting condition as at least one target photo;
a screening module that selects, under a screening condition, one of the at least one target photo in each preset period as a representative photo respectively;
at least one network transmission module that transmits image data, the image data comprising at least one of the image frames, the at least one target photo, and the representative photos; and
at least one network receiving module that receives the image data transmitted by the at least one network transmission module.

7. The baby photo recording system according to claim 6, further comprising: a recording module that places the representative photos into a record template to form a photo record.

8. The baby photo recording system according to claim 6, further comprising: a network photographic device and a first remote processing device, wherein
the at least one network transmission module comprises a first network transmission module, and the at least one network receiving module comprises a first network receiving module; wherein
the image module, the analysis module, and the first network transmission module are sequentially electrically connected to be disposed in the network photographic device; wherein
the first network receiving module and the screening module are sequentially electrically connected to be disposed in the first remote processing device; and wherein
the first network transmission module transmits the at least one target photo to the first network receiving module.

9. The baby photo recording system according to claim 8, further comprising a second remote processing device, wherein
the at least one network transmission module further comprises a second network transmission module, and the at least one network receiving module further comprises a second network receiving module; wherein
the second network transmission module is disposed in the first remote processing device and electrically connected to the screening module, and the second network receiving module is disposed in the second remote processing device; wherein
the second network transmission module transmits the representative photos selected by the screening module to the second network receiving module; and wherein
the second remote processing device further comprises a recording module, electrically connected to the second network receiving module to place the representative photos in a record template to form a photo record.

10. The baby photo recording system according to claim 8, further comprising a recording module, the recording module being disposed in the first remote processing device to place the representative photos in a record template to form a photo record.

11. The baby photo recording system according to claim 6, wherein the analysis module analyzes the image frames, and records a time stamp corresponding to the image frame meeting the shooting condition in metadata; and wherein the screening module analyzes the image frame corresponding to the time stamp according to the metadata, to capture at least one of the image frames meeting the shooting condition as the target photo.

12. The baby photo recording system according to claim 6, further comprising a network photographic device and a first remote processing device, wherein
the at least one network transmission module comprises a first network transmission module, and the at least one network receiving module comprises a first network receiving module; wherein
the image module and the first network transmission module are sequentially electrically connected to be disposed in the network photographic device; wherein
the first network receiving module, the analysis module, and the screening module are sequentially electrically connected to be disposed in the first remote processing device; and wherein
the first network transmission module transmits the image frames to the first network receiving module.

13. The baby photo recording system according to claim 12, further comprising a second remote processing device, wherein
the at least one network transmission module further comprises a second network transmission module, and the at least one network receiving module further comprises a second network receiving module; wherein
the second network transmission module is disposed in the first remote processing device and electrically connected to the screening module, and the second network receiving module is disposed in the second remote processing device; wherein
the second network transmission module transmits the representative photos selected by the screening module to the second network receiving module; and wherein
the second remote processing device further comprises a recording module, electrically connected to the second network receiving module to place the representative photos in a record template to form a photo record.

14. The baby photo recording system according to claim 12, further comprising a recording module, the recording module being disposed in the first remote processing device to place the representative photos in a record template to form a photo record.

15. The baby photo recording system according to claim 6, further comprising a network photographic device and a first remote processing device, wherein
the at least one network transmission module is a first network transmission module, and the at least one network receiving module is a first network receiving module; wherein
the image module, the analysis module, the screening module, and the first network transmission module are sequentially electrically connected to be disposed in the network photographic device, and the first network receiving module is disposed in the first remote processing device; and wherein
the first network transmission module transmits the representative photos selected by the screening module to the first network receiving module.

16. The baby photo recording system according to claim 15, further comprising a recording module, the recording module being disposed in the first remote processing device to place the representative photos in a record template to form a photo record.

17. A computer program product, executed by a remote processing device, and cooperating with the baby photo recording system according to claim 6, the computer program product comprising:
a communication module that receives the representative photo in each default period via a network interface; and
a record generation module that places the representative photos in a record template to form a photo record.

18. The computer program product according to claim 17, wherein the communication module further receives the target photos via the network interface, and the computer program product further comprises:
a photo browsing module that displays the target photos corresponding to a particular period via a screen, and, in response to an input, selects one of the target photos corresponding to the particular period as an alternate photo via an input interface; wherein the record generation module changing the representative photo in the photo record corresponding to the particular period into the alternate photo.

19. The computer program product according to claim 17, further comprising:
a photo update module that receives an updated photo imported externally, wherein the record generation module changing the representative photo in the photo record corresponding to a particular period into the updated photo.

20. The computer program product according to claim 17, further comprising:
a desktop setting module that periodically sets the representative photo in each preset period as an operating system scenery of the remote processing device.
